(19) United States
(12) Patent Application Publication
(10) Pub. No.: US 2006/0083020 A1
(43) Pub. Date: Apr. 20, 2006

(54) Diffuser in direct back light module

(76) Inventors: Chung-Yung Tai, Kaohsiung City (TW); Yi-Fang Lin, Kaohsiung Hsien (TW); Yen Chuan Chu, Kaohsiung City (TW); Ying-Fu Wang, Taipei (TW)

Correspondence Address: LEONG C LEI, PMB # 1008, 1867 YGNACIO VALLEY ROAD, WALNUT CREEK, CA, 94598, US

(21) Appl. No.: 10/964,663

(22) Filed: Oct. 15, 2004

(51) Int. Cl. G02B 5/02

(52) U.S. Cl. 362/558; 362/225

(57) ABSTRACT

A diffuser in a direct back light module comprised of multiple, minute, 3D conductors in staggered arrangement in the plate of the diffuser to permit the light passing through it to have multiple reflections in multiple directions and in turn the consistent diffusion for light source.

### BACKGROUND OF THE INVENTION

(a) Technical Field of the Invention

The present invention is related to a diffuser, and more particularly to one used in a direct back light module.

(b) Description of the Prior Art

TFT-LCD currently a comparatively popular monitor for display is essentially comprised of a panel and a back light module functioning as the light source for the panel. Two types of the back light module are available respectively the side back light module and the direct back light module depending on where the light source is located. The former usually applied in the smaller monitor is adapted with LED or cold cathode tube as the light source while the latter mostly applied in the larger monitor, e.g., that for a TV set, essentially has the cold cathode tube as the light source.

As illustrated in FIG. 1 of the accompanying drawings, a direct back light module 1 of the prior art contains a casing 11 generally coated on its inner side reflective coating or attached with a layer of a reflection film 12 to reflect the light from the light source; multiple cold cathode tubes 13 arranged in sequence at a certain spacing, a diffuser 14 provided over those cold cathode tubes 13, one or multiple light diffusion film 15 or prism sheet 16 over the diffuser 14 and finally a panel A to form a TFT-LCD.

When those cold cathode tubes 13 in the casing 11 are conducted as illustrated in FIG. 2, certain parts of the light emitted directly enter into the diffuser 14 while other parts reflect back to other positions in the casing 11 to be reflected again by the reflection film 12 for the light to reenter into the diffuser for consistent diffusion. Light is collected and converged through the prism sheet 16 before being delivered to the panel A for the panel to obtain sufficient and consistent light source for display purpose.

The diffuser 14 is related to a plate made of PMMA, PC or PM and MS copolymers given with a certain light penetration. To achieve the purpose of consistent diffusion of the light source, pigment is added in the process for the diffuser 14 to indicate milk white to facilitate consistent diffusion of the light source. In some cases, multiple minute diffusion particles 140 are added as illustrated in FIG. 3 for the light passing through them to reflect or diffuse for achieving the purpose of consistent diffusion.

However, as illustrated in FIG. 4, those diffusion particles 140 are integrated with the base material of the diffuser 14; therefore, they are evenly distributed in the diffuser 14. Accordingly, when the light is emitted from each of those cold cathode tubes 13 located below the diffuser, the area directly above each of those cold cathode tubes 13 has the most lights thus is brighter. Even though the diffuser 14 has already contains many diffuser particles 140, the light diffusion effect at each position of the diffuser 14 is the same. The area directly above each of those cold cathode tubes 13 though receiving higher luminance from the light source fails to relatively obtain higher light diffusion effect, instead, only the same light diffusion effect is obtained as any other position of the diffuser. On the other hand, the luminance in the area directly above each of those cold cathode tubes 14 is highlighted due to insufficient diffusion efficacy. The presence of a diffusion film 15 though could help improve the diffusion efficacy, the results is very limited. Stripes eventually appear on the entire diffuser 14 to have negative impacts on the subsequent use of the light source for the panel A.

Several improvements have been developed to correct the flaw observed with the diffuser 14. As illustrated in FIG. 5, one improvement involves the formation of a thinner part 142 sandwiched by two thicker parts 141 on the diffuser 14 at where directly above each of those cold cathode tubes 13 for the thicker part 141 having larger volume contains more diffusion particles 140 to reflect more light in an attempt to overcome the inconsistent diffusion by the diffuser 14. However, the consistency of the material and the stress of the finished product of the diffuser are under very strict trails and demands for the formation of those thicker parts 141 and the thinner part 142, in turn, great challenges to the process. Furthermore, the basic demand of having a compact diffuser frustrates the attempt of having thicker parts. The difference of the quantity of diffusion particles between the thicker part 141 and the thinner part 142 of a diffuser 14 is very mild due to the fact that the difference of thickness between the thicker part 142 and the thinner part 141 is held to its minimum. As a result, the performance of the light reflection efficacy remains insufficient.

Another attempt as illustrated in FIG. 6 involves the design of the formation of dots 144 by using the printing or sandblasting method on an incidence plane 143 of the diffuser 14 (the surface approaching that of the cold cathode tubes 13) at where in relation to the location of the code cathode tubes 13 to reflect or diffuse the light for eliminating the inconsistent diffusion by the diffuser 14. However, those dots 144 are only provided on the face of the incidence plane 143 of the diffuser. Even the area of those dots 144 are made to the minimum to pay for higher density, those dots 144 reflect the higher luminance light emitted from those cold cathode tubes 13 only once and the reflection efficacy is very limited to fail attaning the purpose of effective diffusion or even a consistent diffusion by the diffuser.

The direct back light module of the prior art fails to provide good quality back light source for application. Therefore, how to provide a consistent back light for the direct back light module to prevail its optimal application becomes the bottleneck for the trade to seek the breakthrough.

### SUMMARY OF THE INVENTION

The primary purpose of the present invention is to provide a diffuser in a direct back light module that contains multiple minute solid light conductors for the light in the diffuser to have multiple reflections in multiple directions for achieving the purpose of a consistent diffusion of light source.

Another purpose of the present invention is to provide a diffuser in a direct back light module that achieves the purpose of a consistent diffusion of light source by having arranged those multiple minute light conductors in a staggered fashion.

Another purpose of the present invention yet is to provide a diffuser in a direct back light module that the density of the minute light conductors in the diffuser at where closer to the brighter area of those cold cathode tubes is greater than the darker area for the light passing through the brighter area to have more reflections for better diffusion of the light source.

Another purpose of the present invention yet is to provide a diffuser in a direct back light module that has those multiple light conductors in the diffuser made in various sizes and disposed at different locations in the diffuser to help achieve the consistent diffusion for the light source.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a basic construction of a direct back light module of the prior art.

FIG. 2 is a schematic view showing the operation of the prior art illustrated in FIG. 1.

FIG. 3 is the construction of the light diffusion by a diffuser of the prior art illustrated in FIG. 1.

FIG. 4 is a schematic view showing the operation of the prior art illustrated in FIG. 3.

FIG. 5 is a schematic view of a basic construction of a direct back light module of another prior art.

FIG. 6 is the construction of the light diffusion by a diffuser of another prior art illustrated in FIG. 5.

FIG. 7 is a schematic view of a basic construction of a direct back light module of the present invention.

FIG. 8 is a perspective view of the diffusion structure of the diffuser illustrated in FIG. 7.

FIG. 9 is a schematic view of an application of the present invention.

FIG. 10 is a schematic view of another preferred embodiment of the present invention.

FIG. 11 is a schematic view showing a manufacturing process of the present invention.

FIG. 12 is a schematic view showing another manufacturing process of the present invention.

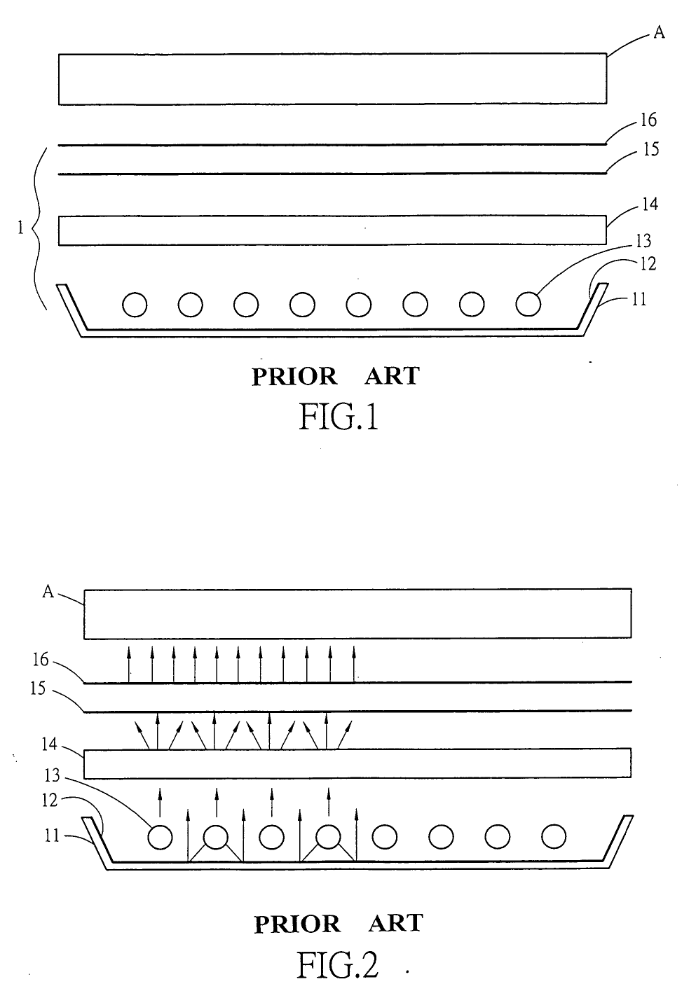

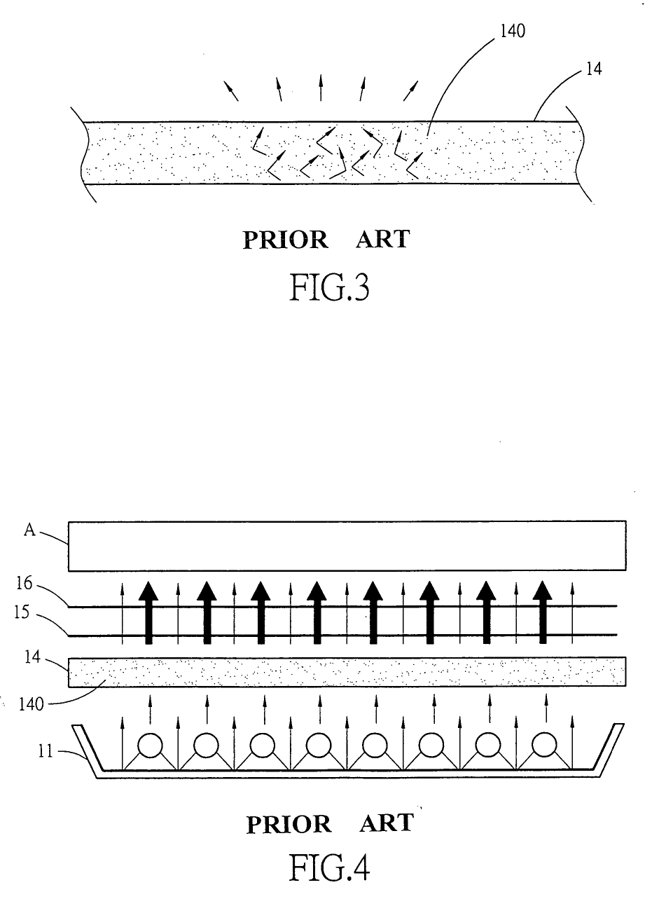

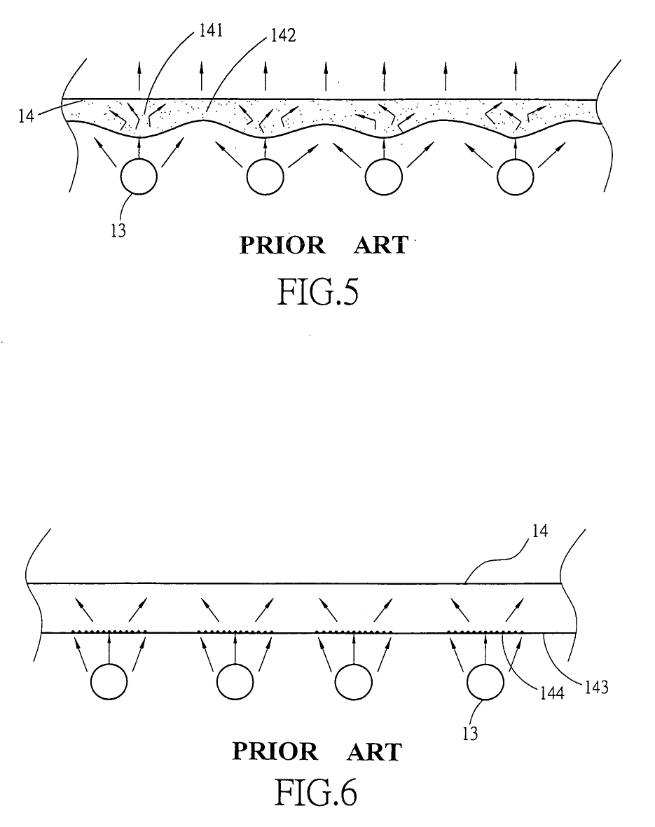

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

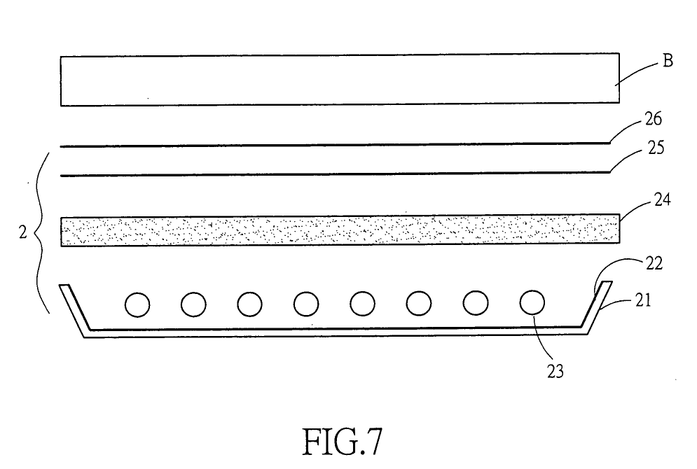

Referring to FIG. 7, a direct back light module 2 of the present invention is essentially comprised of a casing 21 with its inner side applied with a reflection coating or attached with a reflection film 22 to reflect the light source, multiple cold cathode tubes 23 arranged in sequence at a given spacing; and a diffuser 24 for consistent diffusion of the light source provided over those cold cathode tubes. A light diffusion film 25 and a prism sheet 26 are provided over the diffuser 24, and finally a display panel B is incorporated to form a TFT-LCD.

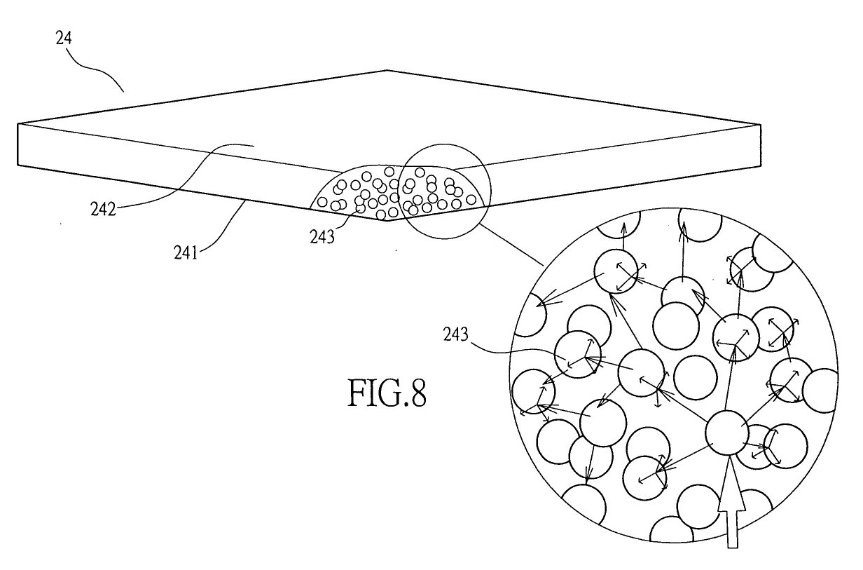

As illustrated in FIG. 8, the diffuser is related to a plate given with a certain light penetration made of PMMA or PC, or copolymer of PMMA and MS. The side of the diffuser facing those cold cathode tubes 23 is the light incidence plane 241 and the other side of the diffuser 24 relates to a light export plane 242. Wherein, multiple minute solid light conductors 243 are arranged in staggered fashion in the diffuser 24. The light conductor 243 may be provided in the form of a polyhedron, spherical or oval balls so to reflect in multiple directions the light entering into the incidence plane 241 of the diffuser 24 and contacting those light conductors 243. As illustrated in FIG. 8 for a magnified local part of the present invention, multiple reflections occur in the diffuser 24 to achieve the consistent diffusion before quitting from the light export plane 242 of the diffuser 24.

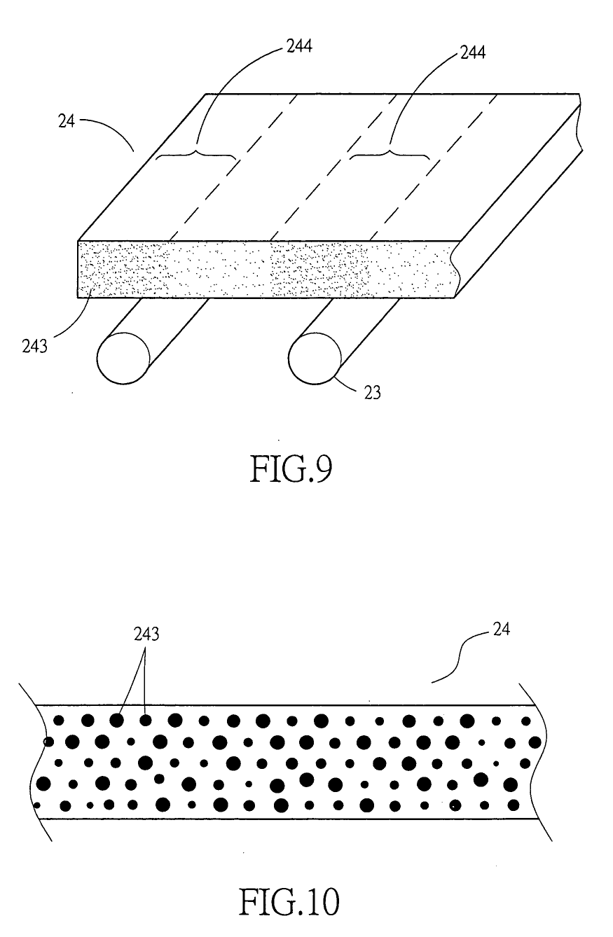

Now referring to FIG. 9, a brighter area 244 is formed to the diffuser directly above each cold cathode tube 23 in relation to the diffuser 24 at where closer to the cold cathode tube 23. Therefore, multiple light conductors 243 in greater size or density are allotted to the brighter area 244. Whereas the presence of those light conductors 243 is not only limited to the surface of the incidence plane of the diffuser 24, it spreads all over from the incidence plane 241 up to the light export plane 242 in the entire interior of the diffuser 24, the quantity of the light conductor 243 in the brighter area is relatively much greater, meaning that the density of the light conductor 243 is increased to a considerable large value to execute the most effective and most multiple reflections of the high luminance light emitted form those cold cathode tubes 23 to provide even more complicate reflection and upgrade the light source diffusion effect so that the light source upon quitting from the diffuser 24 out of its light export plane 242 has already become an extremely consistent light source to facilitate the application by the display panel B.

As illustrated in FIG. 10, those light conductors 243 are made in various sizes and distributed at various locations in the diffuser 24 to further control the reflection and diffusion efficacy at different locations in the diffuser to help achieve consistent diffusion.

The proper amount of pigment may be added in the process of the diffuser 24 to make it indicate milk white in conjunction with the formation of the light conductor 23 for further improve the consistent diffusion of the light source.

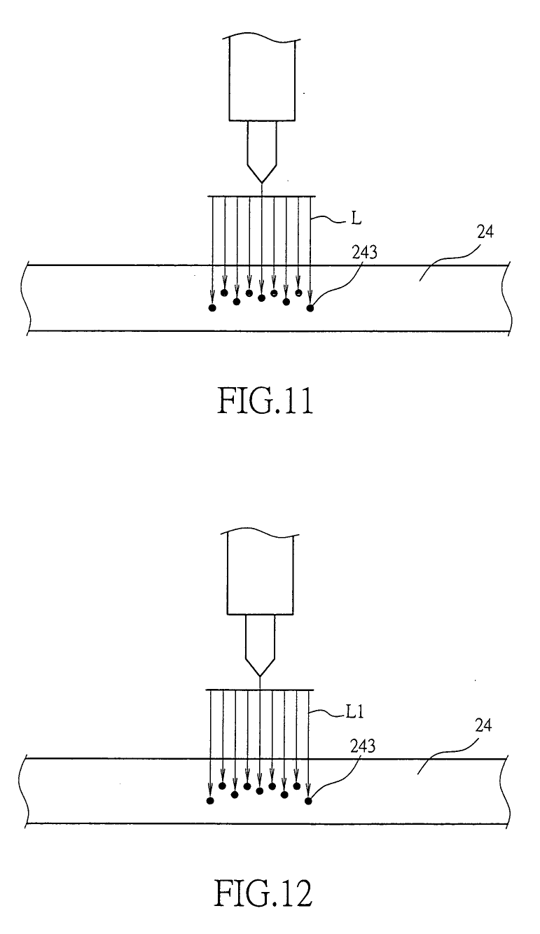

The formation of the light conductor 243 of the light diffusion structure in the diffuser is achieved by the application of the laser beams as illustrated in FIG. 11. Wherein, a laser generator outputs beams of long wave and a preset area on the diffuser 24 is exposed to the emission of multiple laser beams L of long wave formed by the laser mask. A site to converge each laser beam L is preset in the exposure area of the diffuser. The energy provided by the laser beam L is controlled and each location in the diffuser 24 preset to focus the laser beam L is fused to rearrange the molecules of the substance at that location of the diffuser 24 depending on the laser beam energy, exposure time, size of focusing, and the properties of the material of the diffuser 24, and each location of focus is later crystallized when cooled down to form an opaque, solid light conductor 24. The massive formation of the light conductor 243 helps the light entering into the diffuser and passing through the light conductor 243 to be reflected and cause multiple reflections among those light conductors 243 to have optimal diffusion of the light source.

As illustrated in FIG. 12, the short wave laser beam (UV) can be also applied. Wherein, a laser generator outputs short wave beams and a preset area on the diffuser 24 is exposed to the emission of multiple laser beams L1 of short wave formed by the laser mask. A location of focusing is preset for each short wave laser beam L1 in the exposure area of the diffuser 24. With the energy of the those short wave laser beams L1 under control in conjunction with the laser beam energy, exposure time, size of focusing and the properties of the material of the diffuser, molecular bonds of the material at the focusing location in the diffuser exposed to the short wave laser beam L1 is destroyed, and at the same time of the destruction takes place, the light conductor 243 is further made in the form of polyhedron, or spherical or oval balls. Since the molecular bonds in the light conductor 243 has been destroyed, its deflection rate is different from that of the raw material of the diffuser 24 and the interface so created produces light reflection and scattering. The massive formation of the light conductor 243 causes the light passing through the light conductors to reflect and scatter for creating multiple reflections to diffuse the light source among them.

The present invention by using the laser beam to enter into the diffuser for the formation of multiple light conductors in different density and size arranged in a 3D staggered fashion for the light source to achieve multiple reflections in multiple directions and thus a consistent diffusion has improved the diffuser in comparison with the prior art that has the dots on the surface of the diffuser by printing or sandblasting to reflect the light source only once. Furthermore, the light conductor of the present invention is directly formed in the plate of the diffuser without adding diffusion particles to eliminate the problems of inconsistent distribution of the light source and inner stress due to the mixture of two different substances of the diffuser and the diffusion particles. The construction of the present invention is also much simple to prevent problems derived from the production of the diffuser because no complicate shape of the diffuser is required to compromise the location of the cold cathode tube. The present invention does achieve its industrial purpose, is innovative and advanced, and has not yet been available in the market. Therefore, this application for a patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A diffuser in a direct back light module includes a casing having on its inner side applied with a reflective coating or attached with a reflection film; multiple cold cathode tubes arranged in sequence at a given spacing in the casing; a diffuser proved above those cold cathode tubes; and multiple solid, opaque, and minute light conductors being distributed and arranged in 3D staggered fashion in the diffuser.

2. The diffuser in a direct back light module of claim 1, wherein, the light conductor is made in the form of a polyhedron.

3. The diffuser in a direct back light module of claim 1, wherein, the light conductor is made in the form of a ball.

4. The diffuser in a direct back light module of claim 1, wherein, the light conductor is mad in the form of an oval ball.

5. The diffuser in a direct back light module of claim 1, wherein, the density of those light conductors in a brighter area of each cold cathode tube at where in relation to the diffuser is higher than that of any location of the diffuser other than the brighter area.

6. The diffuser in a direct back light module of claim 1, wherein, it contains multiple light conductors made in different sizes.

7. A diffuser in a direct back light module essentially formed by having preset multiple focusing locations to be exposed to laser beams; each focusing location being exposed to long wave laser beams outputted from a laser generator; each focusing location after exposure to the mask being fused to rearrange the molecules of the substance at that location; molecules so rearranged when cooled down being crystallized into multiple opaque solid light conductors; and the massive formation of the light conductors constituting the diffusion structure for the diffuser.

8. A diffuser in a direct back light module essentially formed by having preset multiple focusing locations to be exposed to laser beams; each focusing location being exposed to short wave laser beams outputted from a laser generator; molecular bonds of the material at each focusing area within the exposure area being destroyed after exposure to the laser mask to produce multiple solid light conductors; and the massive formation of the light conductors constituting the diffusion structure for the diffuser.
